(19) United States
(12) Patent Application Publication
(10) Pub. No.: US 2004/0179478 A1
(43) Pub. Date: Sep. 16, 2004

(54) Physical layer (PHY) with power off alert (POA) and alerting method thereof

(76) Inventors: Chieh-Yuan Ke, Hsinchu (TW); Tsu-Chun Liu, Hsinchu (TW); Tien-Ju Tsai, Changhua (TW); Chung-Cheng Chen, Hsinchu (TW); Jean-Ming Lee, Hsinchu (TW); Kun-Che Chung, Jungpu Shiang (TW)

Correspondence Address: WU & CHEUNG, LLP, Suite 710, 7700 IRVINE CENTER DRIVE, Irvine, CA, 92618-3043, US

(21) Appl. No.: 10/453,756

(22) Filed: Jun. 2, 2003

(30) Foreign Application Priority Data
Mar. 3, 2003 (TW) 92104356

(51) Int. Cl. H04J 1/16

(52) U.S. Cl. 370/242; 370/216

(57) ABSTRACT

A physical layer with power off alert (POA) and the alerting method thereof. It uses a power detector to detect the power supplied to the physical layer, and uses a POA packet generator to generate a POA packet when the supplied power is off. Therefore, it can use the POA packet transmitted on the network to notify the user of the opposite nodes or other nodes on the network.

### CROSS-REFERENCE TO RELATED APPLICATION

This application claims the priority benefit of Taiwan application serial no. 92104356, filed Mar. 3, 2003.

### BACKGROUND OF THE INVENTION

1. Field of Invention

The present invention generally relates to a physical layer, and more particularly, to a physical layer (PHY) with power off alert (abbreviated as POA) and the alerting method thereof.

2. Description of Related Art

Due to the progress of electronic techniques, computers and various information digital devices have been gradually accepted and are now widely used. In order to achieve the object of sharing resources, network has become essential equipment for exchanging information. In various network equipment, due to having characteristics of easy acquiring, convenience setup, and fast transmission rate, equipment related to Ethernet have vigorously developed, and its transmission rate has upgraded from 10 Mbps to 100 Mbps and even 1 Gbps.

In Ethernet equipment, the network nodes such as Ethernet Switch or network adapter receive the packet transmitted on the network via the physical layer that provides the network connection port, so as to achieve the object of exchanging information and sharing resources. Further, each network node also demands a power supply for providing power for its normal operation. However, in the prior art, when the power of network node is accidentally lost, for example, the power is turned off due someone accidentally unplugging the power line, other network nodes connected to it cannot recognize this power lost situation. Therefore, it generates a negative result of network disconnecting and also brings a great inconvenience to users.

### SUMMARY OF THE INVENTION

To solve the problem mentioned above, the present invention provides a physical layer (PHY) with power off alert (POA) and the alerting method thereof. It can issue a power off alert when the supplied power is off by using its residual power to notify other nodes on the network.

In order to achieve the object mentioned above and others, the present invention provides a physical layer with POA. It is suitable for transmitting and receiving the packet, such as the Ethernet packet, and also has an access interface that connects to a Media Access Controller (abbreviated as MAC), such as the access interface among the MII/RMII/SMII/SS-SMII/GMII/RGMII/SGMII/TBI/RTBI. The physical layer with POA at least comprises a power detector, a POA packet generator, a multiplexer circuit, and a packet transmitter.

Wherein, the power detector is used to detect the power supplied to the physical layer, and issue an indicating control signal when the supplied power is off. The POA packet generator couples to the power detector and sends out a POA packet after receiving the indicating control signal mentioned above. The multiplexer circuit couples to the power detector and the POA packet generator and selectively switches the packet transmitting path from the access interface of the MAC to the POA packet generator when it receives the indicating control signal mentioned above. The packet transmitter couples to the multiplexer circuit and transmits the POA packet to the network.

In a preferred embodiment of the present invention, the physical layer with POA further comprises a packet receiver and a POA packet discriminator. Wherein, the packet receiver receives and recovers the packet signal transmitted on the network. The POA packet discriminator couples to the packet receiver and issues an alert message after receiving the POA packet from the packet receiver.

The alert message mentioned above can be stored in the register of the physical layer for reading by the upper layer device. The alert message mentioned above also can be used to drive a LED (Light Emitting Diode) display so as to notify the user of the physical layer that receives POA packet.

In one embodiment of the present invention, the POA packet is a 64 bytes IEEE standard format broadcast packet. Further, in the other embodiment, the POA packet is 11 bytes non-IEEE standard format IC+ management packet.

The present invention further provides a physical layer power off alerting method. The method comprises the steps of: first, detecting the power supplied to the physical layer, then issuing an indicating control signal when the power is off; and, finally, sending out a POA packet that indicates that the power is off according to the indicating control signal.

In the preferred embodiment of the present invention, the physical layer power off alerting method further comprises the steps of: determining the packet received by the physical layer, and issuing an alert message when the packet received is determined as the POA packet mentioned above.

In one embodiment, the physical layer power off alerting method further comprises the step of storing the alert message in the register of the physical layer.

In one embodiment, the physical layer power off alerting method further comprises the step of using the alert message to drive the LED display.

In one embodiment, the POA packet is a 64 bytes IEEE standard format management packet.

In the other embodiment, the POA packet is an 11 bytes non-IEEE standard format management packet.

In summary, the physical layer with POA and the alert method provided by the present invention applies its residual power to issue a POA packet to notify the opposite nodes or other nodes on the network when the supplied power is off, and also stores and displays the POA message to notify user when it receives the POA packet.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a block diagram of a physical layer with POA of a preferred embodiment according to the present invention.

FIG. 2 schematically shows a POA packet format of a preferred embodiment according to the present invention.

### DESCRIPTION OF THE PREFERRED EMBODIMENTS

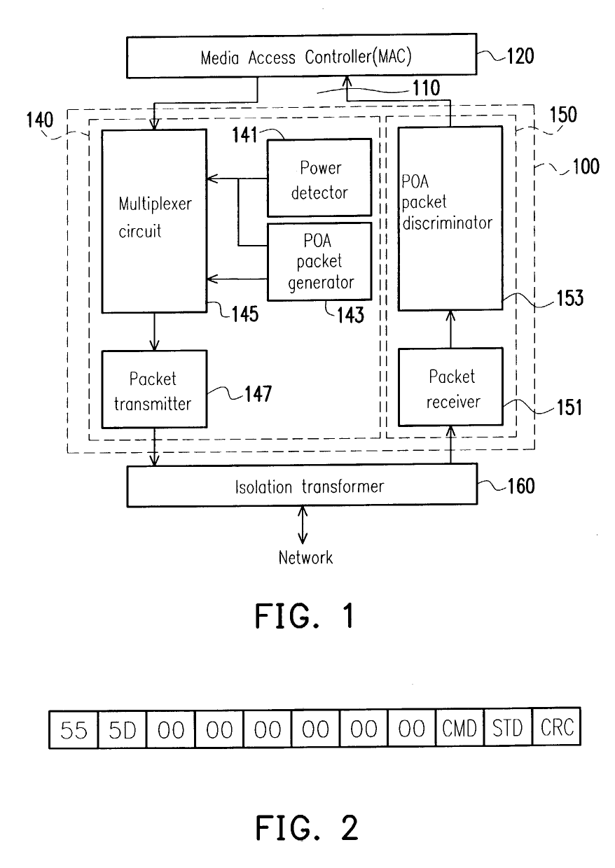

Referring to FIG. 1, it schematically shows a block diagram of a physical layer with POA of a preferred embodiment according to the present invention. As shown in the diagram, the physical layer with POA 100 is such a Ethernet physical layer, it connects to a MAC 120 via an access interface 110 such as an access interface among the MII, RMII, SMII, SS-SMII, GMII, RGMII, SGMII, TBI, or RTBI. Depending on whether the physical layer with POA 100 is applied onto the computer or the network node of the network switch, the MAC 120 may be either a MAC in the network adapter or in the network switch.

As shown in FIG. 1, the physical layer with POA 100 comprises a transmitter circuit block 140 and a receiver circuit block 150. The transmitter circuit block 140 receives the network packet transmitted by the MAC 120 via the access interface 110, converts it to an analog packet, and transmits it to the network by using an isolation transformer 160. The receiver circuit block 150 receives the analog packet from the network via the isolation transformer 160, and converts it to a digital signal for accessing by the MAC 120.

As shown in the diagram, the transmitter circuit block 140 of the physical layer with POA 100 comprises: a power detector 141, a POA packet generator 143, a multiplexer circuit 145, and a packet transmitter 147. The receiver circuit packet 150 comprises a packet receiver 151 and a POA packet discriminator 153. The POA packet generator 143 couples to the power detector 141 and the multiplexer circuit 145. The multiplexer circuit 145 couples to the power detector 141 and the packet transmitter 147. The packet receiver 151 couples to the POA packet discriminator 153.

Wherein, the power detector 141 detects the power supplied to the physical layer with POA 100 and issues an indicating control signal when the supplied power is off. The indicating control signal selectively switches the packet transmitting path of the multiplexer circuit 145 from the access interface 110 connected to the MAC 120 to the POA packet generator 143, so that the POA packet generated by the POA packet generator 143 can drive and transmit the POA packet onto the network by the switching of the multiplexer circuit 145 and the packet transmitter 147.

Certainly, the physical layer with POA 100 can further comprise a register for setting up the bit for enabling the POA function or not, the bit for setting the POA packet type, and the bit for setting the interval of the continuously transmitting POA packet, so that different types of operation mode can be selected based on different user requirements.

It is assumed that the receiver circuit block 150 of the opposite node connected to this node on the network is as shown in FIG. 1, after the packet receiver 151 receives and converts the packet signal transmitted on the network, the POA packet discriminator 153 determines whether the received packet is the POA packet that indicates the opposite node has lost its power or not, and issues an alert message if it is. The alert message can be stored in the register of the physical layer with POA 100 to be read by the upper layer devices, it can also be used to drive the external LED display to notify the user of this node.

Preferably, the length of the POA packet mentioned above is not too long, a 64 bytes IEEE standard format broadcast packet can be used, so that the node that receives the packet can broadcast it to other nodes. Optionally, the packet with user defined format also can be used, such as the 11 bytes non-IEEE standard format IC+ management packet as shown in FIG. 2.

Referring to FIG. 2, the total length of the POA packet is 11 bytes. Wherein, the first byte “55” is a preamble byte, the second byte “5D” is a start frame delimiter (STD), the 3^{rd} to 8^{th} bytes are the empty bytes with value “00”, the 9^{th} byte is a command byte in which the first bit is used as a POA indicator in the present embodiment and other bits are the reserved bits, the 10^{th} byte is a status byte that is not used in the present embodiment, and the 11^{th} byte is a CRC (Cyclic Redundancy Code) code.

From the descriptions above, a physical layer power off alerting method can also be induced. The method comprises the steps of: first, detecting the power supplied to the physical layer, then issuing an indicating control signal when the power is off; and, finally, sending out a POA packet that indicates the power is off based on the indicating control signal.

If the operation of the receiver circuit block 150 is also considered, the physical layer power off alerting method further comprises the steps of: determining the packet received by the physical layer, and issuing an alert message when the received packet is the POA packet mentioned above. The alert message can be stored in the register of the physical layer or can be used to drive the LED display.

The POA packet mentioned above can be either a 64 bytes IEEE standard format broadcast packet or an 11 bytes non-IEEE standard format management packet as shown in FIG. 2.

In summary, the present invention at least has following advantages:

1. It can use the residual power to issue the POA packet to notify the opposite nodes or other nodes on the network when the supplied power is off.

2. It can store and display the POA packet when it receives the POA packet, so as to notify the user for preventing the users from stepping into an unknown situation.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A physical layer with power off alert (POA), suitable for transmitting and receiving a packet on a network, and has an access interface that connects to a Media Access Controller (MAC), comprising:
a power detector, used to detect a power supplied to the physical layer, and issue an indicating control signal when the power is off;
a POA packet generator, coupled to the power detector, used to send out a POA packet when the indicating control signal is received;
a multiplexer circuit, coupled to the POA detector and the POA packet generator, used to selectively switch a packet transmitting path from the access interface to the POA packet generator; and
a packet transmitter, coupled to the multiplexer circuit, used to drive and transmit the POA packet onto the network.

2. The physical layer with POA of claim 1, further comprising:
a packet receiver, used to receive and recover the packet signal transmitted on the network; and
a POA packet discriminator, coupled to the packet receiver, and used to issue an alert message when it receives the POA packet from the packet receiver.

3. The physical layer with POA of claim 2, wherein the alert message is stored in a register of the physical layer.

4. The physical layer with POA of claim 2, wherein the alert message is used to drive a LED display.

5. The physical layer with POA of claim 1, wherein the POA packet is a 64 bytes IEEE standard format broadcast packet.

6. The physical layer with POA of claim 1, wherein the POA packet is an 11 bytes non-IEEE standard format management packet.

7. The physical layer with POA of claim 1, wherein the network is an Ethernet.

8. The physical layer with POA of claim 1, wherein the access interface is one of the MII/RMII/SMII/SS-SMII/GMII/RGMII/SGMII/TBI/RTBI.

9. A physical layer power off alerting method, comprising:
detecting a power supplied to the physical layer, and issuing an indicating control signal when the power is off; and
issuing a POA packet based on the indicating control signal.

10. The physical layer power off alerting method of claim 9, further comprising:
determining the packet received by the physical layer; and
issuing an alert message when the received packet is the POA packet.

11. The physical layer power off alerting method of claim 10, further comprising a step of storing the alert message in a register of the physical layer.

12. The physical layer power off alerting method of claim 10, further comprising a step of using the alert message to drive a LED display.

13. The physical layer power off alerting method of claim 9, wherein the POA packet is a 64 bytes IEEE standard format broadcast packet.

14. The physical layer power off alerting method of claim 9, wherein the POA packet is an 11 bytes non-IEEE standard format management packet.

15. The physical layer power off alerting method of claim 9, wherein the physical layer is an Ethernet physical layer.
